(19) United States
(12) Patent Application Publication
(10) Pub. No.: US 2016/0197957 A1
(43) Pub. Date: Jul. 7, 2016

(54) APPARATUS FOR MEASURING SIMILARITY BETWEEN INTRUSION DETECTION RULES AND METHOD THEREFOR

(71) Applicant: ELECTRONICS AND TELECOMMUNICATIONS RESEARCH INSTITUTE, Daejeon (KR)

(72) Inventors: Jaesung LEE, Daejeon (KR); Yujeong HAN, Pyeongtaek-si (KR); Byungchul BAE, Daejeon (KR); HyungGeun OH, Daejeon (KR); Kiwook SOHN, Daejeon (KR)

(21) Appl. No.: 14/909,580

(22) PCT Filed: Jul. 14, 2014
(86) PCT No.: PCT/KR2014/006318

§ 371 Date: Feb. 2, 2016

(30) Foreign Application Priority Data
Aug. 26, 2013 (KR) 10-2013-0101205

(51) Int. Cl. H04L 29/06

(52) U.S. Cl. CPC H04L 63/20; H04L 63/0263

(57) ABSTRACT

The present invention relates to an apparatus and method that check similarity between intrusion detection rules used by an Intrusion Detection System. The apparatus for measuring similarity between intrusion detection rules includes a normalization unit for modifying a plurality of detection rules in a predetermined form, a division unit for dividing each of detection rules among a plurality of modified detection rules into a detection rule header and a detection rule option, a relationship operation unit for determining an inclusion relationship between a detection rule headers, and determining an inclusion relationship between a detection rule options, and a similarity measurement unit for measuring similarity between the detection rules based on the inclusion relationship between the detection rule headers and the inclusion relationship between the detection rule options.

### TECHNICAL FIELD

The present invention relates, in general, to an apparatus and method for measuring similarity between intrusion detection rules and, more particularly, to an apparatus and method that cheek similarity between intrusion detection rules used by an Intrusion Detection System (IDS), detect an inclusion relationship between the intrusion detection rules, and measure intrusion detection similarity based on the results of detecting the inclusion relationship.

### BACKGROUND ART

A conventional method of checking similarity between detection rules is configured to recognize each detection rule as a simple character string, and determine whether duplication is present between detection rules by comparing character strings with each other. This method is problematic in that, even if a meaningless blank is included in the detection rules, the detection rules are determined to be different detection rules. Further, the determination of whether duplication between detection rules occurs by simply comparing character strings is configured such that the ranges of detection that are principal characteristics of detection rules cannot be compared with each other, thus making it impossible to determine similarity between substantial detection rules.

For example, Korean Patent No. 10-0912541 entitled “Apparatus and method for managing intrusion detection rules in Internet Protocol Version 4 (IPv4)/Internet Protocol Version 6 (IPv6) hybrid network in an integrated manner” discloses technology which analyzes an association between an IPv4 address and an IPv6 address included in externally received intrusion detection rules, automatically converts the received intrusion detection rules using the results of the analysis, stores the converted intrusion detection rules in a corresponding database (DB), and manages the converted intrusion detection rules and association information in an integrated manner.

Currently, there is technology for managing intrusion detection rules in an integrated manner as in the case of the above patent, but checking tools for determining similarity between the detection rules are not present, and for this function, experts in a related field must personally check such similarity.

### DISCLOSURE

### Technical Problem

An object of the present invention is to provide an apparatus and method that check similarity between intrusion detection rules used by an Intrusion Detection System (IDS), detect an inclusion relationship between the intrusion detection rules, and measure intrusion detection similarity based on the results of detecting the inclusion relationship.

### Technical Solution

A method of measuring similarity between intrusion detection rules according to the present invention to accomplish the above object includes modifying a plurality of detection rules stored in a similarity measurement apparatus in a predetermined form; dividing each of a first detection rule and a second detection rule among a plurality of modified detection rules into a detection rule header and a detection rule option; determining an inclusion relationship between a detection rule header of the first detection rule and a detection rule header of the second detection rule; determining an inclusion relationship between a detection rule option of the first detection rule and a detection rule option of the second detection rule; and measuring similarity between the detection rules based on the inclusion relationship between the detection rule headers and the inclusion relationship between the detection rule options.

In this case, measuring the similarity between the detection rules may be configured to compare one or more component values constituting the detection rule header of the first detection rule with one or more component values constituting the detection rule header of the second detection rule, and measure similarity between the detection rules using a ratio of a number of matching component values to a total number of compared component values.

In this case, measuring the similarity between the detection rules may be configured to compare one or more component values constituting the detection rule option of the first detection rule with one or more component values constituting the detection rule option of the second detection rule, and measure similarity between the detection rules using a ratio of a number of matching component values to a total number of compared component values.

In this case, each of the options of the first detection rule and the second detection rule may include content and a modifier.

In this case, each detection rule header may be calculated using an action, a protocol, a source Internet Protocol (IP), a source port, a detection direction, a destination IP, and a destination port.

In this case, a range of each detection rule option may be determined by content and a regular expression corresponding to a detection target character string.

Further, an apparatus for measuring similarity between intrusion detection rules according to an embodiment of the present invention includes a normalization unit for modifying a plurality of detection rules in a predetermined form; a division unit for dividing each of a first detection rule and a second detection rule among a plurality of modified detection rules into a detection rule header and a detection rule option; a relationship operation unit for determining an inclusion relationship between a detection rule header of the first detection rule and a detection rule header of the second detection rule, and determining an inclusion relationship between a detection rule option of the first detection rule and a detection rule option of the second detection rule; and a similarity measurement unit for measuring similarity between the detection rules based on the inclusion relationship between the detection rule headers and the inclusion relationship between the detection rule options.

In this case, the similarity measurement unit may be configured to compare one or more component values constituting the detection rule header of the first detection rule with one or more component values constituting the detection rule header of the second detection rule, and measure similarity between the detection rules using a ratio of a number of matching component values to a total number of compared component values

In this case, the similarity measurement unit may be configured to compare one or more component values constituting the detection rule option of the first detection rule with one or more component values constituting the detection rule option of the second detection rule, and measure similarity between the detection rules using a ratio of a number of matching component values to a total number of compared component values.

In this case, each of the options of the first detection rule and the second detection rule may include content and a modifier.

In this case, a range of each detection rule header may be calculated using an action, a protocol, a source Internet Protocol (IP), a source port, a detection direction, a destination IP, and a destination port.

In this case, a range of each detection rule option may be determined by content and a regular expression corresponding to a detection target character string.

In this case, the similarity measurement unit may lexically compares values of a modifier, among component values of the detection rule options, and represents similarity by a ratio of a number of matching values to a total number of compared values.

In this case, the similarity measurement unit may be capable of setting weights to the modifier values.

### Advantageous Effects

In accordance with the present invention, similarity between intrusion detection rules used by an IDS is checked, so that an inclusion relationship between intrusion detection rules may be detected, and intrusion detection similarity may be measured based on the results of detecting the inclusion relationship.

By means of this, the present invention may optimize intrusion detection rules by automatically checking similarity between a large number of intrusion detection rules, and may improve the detection range of the IDS using the optimized intrusion detection rules. Further, the present invention automatically checks similarity between intrusion detection rules, thus removing errors that may occur in manual checking, and enabling the present invention to be utilized as a realistic tool for checking detection rules.

### DESCRIPTION OF DRAWINGS

FIG. 1 is a diagram schematically showing an apparatus for measuring similarity between intrusion detection rules according to an embodiment of the present invention;

FIG. 2 is a diagram showing the typical format of a detection rule according to an embodiment of the present invention;

FIG. 3 is a diagram showing a normalized detection rule according to an embodiment of the present invention;

FIG. 4 is a diagram showing detection rules before and after conversion is performed according to an embodiment of the present invention;

FIG. 5 is a diagram showing code required to determine an inclusion relationship between detection rules according to an embodiment of the present invention;

FIG. 6 is a diagram showing an example in which an inclusion relationship is determined using the code required to determine an inclusion relationship between the detection rules according to an embodiment of the present invention;

FIGS. 7 and 8 are diagrams showing an inclusion relationship between detection rules according to an embodiment of the present invention;

FIG. 9 is a reference diagram applied to the apparatus for measuring similarity between intrusion detection rules according to an embodiment of the present invention; and

FIG. 10 is a flowchart showing a method for measuring similarity between the intrusion detection rules of a system according to an embodiment of the present invention.

### BEST MODE

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, an apparatus and method that check similarity between intrusion detection rules used by an Intrusion Detection System (IDS), detect an inclusion relationship between the intrusion detection rules, and measure intrusion detection similarity based on the results of detecting the inclusion relationship according to embodiments of the present invention will be described in detail with reference to the attached drawings.

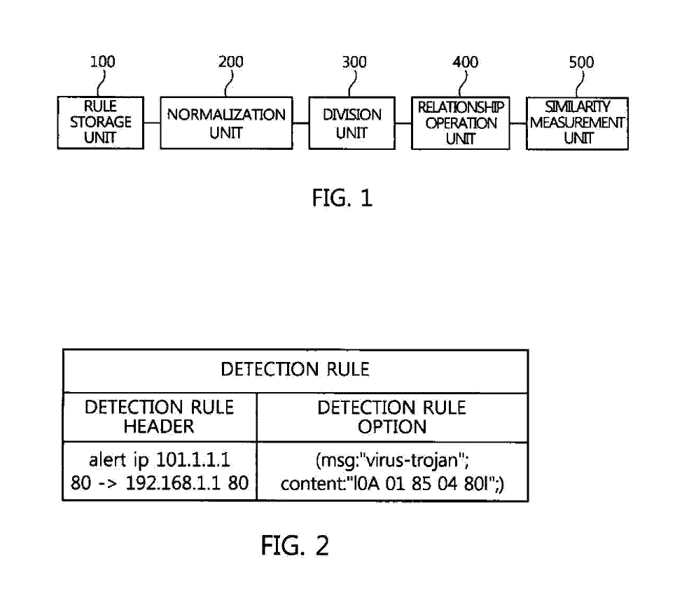

FIG. 1 is a configuration diagram schematically showing an apparatus for measuring similarity between intrusion detection rules according to an embodiment of the present invention. Further, FIGS. 2 to 9 are reference diagrams applied to the apparatus for measuring similarity between intrusion detection rules according to an embodiment of the present invention.

Referring to FIG. 1, an apparatus for measuring similarity between intrusion detection rules includes a rule storage unit 100, a normalization unit 200, a division unit 300, a relationship operation unit 400, and a similarity measurement unit 500.

The storage unit 100 includes different intrusion detection rules (hereinafter also referred to as “detection rules”) for respective intrusion detection systems (IDSs).

The normalization unit 200 performs a normalization procedure for modifying the detection rules stored in the storage unit 100 into a predetermined format.

The division unit 300 divides each of the detection rules, modified into the predetermined format, into a detection rule header and a detection rule option.

For example, the typical format of the detection rule is illustrated in FIG. 2.

A detection rule header describes the operation of processing packets to be detected, and includes an action, a protocol, a source Internet Protocol (IP), a source port, a detection direction, a destination IP, and a destination port.

The principal range of the detection rule header may be calculated using an action, a protocol, a source IP, a source port, a detection direction, a destination IP, and a destination port. In detail, the protocol is configured to calculate a principal range which may be detected by the detection rule header by comparing character strings with each other. Each of the items such as the source IP, the source port, the destination IP, and the destination port may be represented in the form of an integer range to calculate the range, and the remaining items may be configured to intuitively calculate an inclusion relationship via simple comparison.

The principal range of the detection rule option is determined by content and a regular expression (hereinafter also referred to as “pcre: perl compatible regular expressions”) corresponding to a detection target character string. Modifiers such as the offset, distance, depth, and within of the detection rule option may be used to calculate similarity if necessary. Here, the modifiers are used to calculate similarity by lexically comparing the presence or non-presence of the corresponding value, the range of values, etc.

The range of content corresponding to the detection target character string is calculated based on a character string designated by the content. For example, if content: “abc” is designated, the value of “abc” is used without change. The range of pcre corresponding to a detection target character string is converted into a partial character string that may be created using pcre, and the range is designated using the created partial character string. If pcre has grammar for creating an infinite number of partial character strings such ‘.’, ‘+’, ‘*’, and ‘[ ]’, a preset number of partial character strings are created, and then the range of pcre is calculated so that it is identical to the range of content. For example, if pcre: “/a+bc/” is present in a detection rule, partial character strings are created in the form of content: “abc”, content: “aabc”, content: “abbc”, content: “acbc”, . . . .

In this way, the scheme for creating partial character strings may be configured to create partial character strings in an alphabetical order, an inverse alphabetical order, or a random order of partial character strings, as occasion demands. Further, the number of partial character strings to be created may be basically selected as 10,000, but it may be selectively designated by the user depending on the performance of the system.

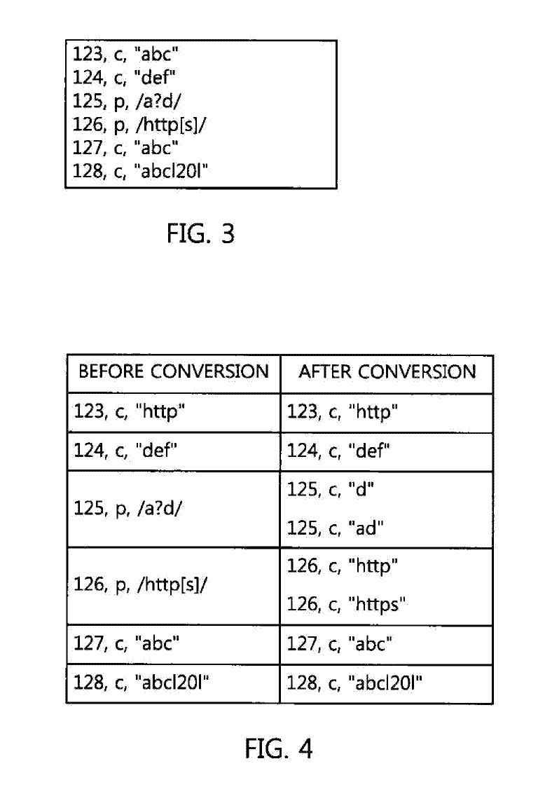

The detection rules modified by the normalization unit 200 in a predetermined form, that is, normalized detection rules, are individually illustrated in FIG. 3.

Each normalized detection rule is described in the form of a detection rule ID, a delimiter, and a detection character string.

Referring to FIG. 3, ‘123’ denotes an ID uniquely identifying each detection rule. c denotes the content of the detection rule option, and is represented by a form put in double quotation marks (“ ”). p denotes pcre of the detection rule option and uses the form described in the detection rule without change.

When the range corresponding to each of the detection rule header and the detection rule option is calculated, all values corresponding to p of the detection rule are converted into character strings. Forms in which values corresponding to p are converted into character strings are shown in FIG. 4. In this case, if the number of partial character strings created by pcre is infinite, only 10,000 partial character strings are basically converted. If necessary, a number of partial character strings identical to the number of partial character strings designated by the user are converted.

Referring to FIG. 4, when a detection rule is ‘125, p, /a?d/’, the option of the detection rule means pcre, and thus all values corresponding to p are converted into character strings, that is, 125, c, “d” or 125, c, “ad”. Further, when a detection rule is ‘126, p, /http[s]/’, the option of the detection rule means pcre, and thus all values corresponding to p are converted into character strings, that is, 126, c, “http” or 126, c, “https”.

The apparatus for measuring similarity between intrusion detection rules according to an embodiment of the present invention may determine an inclusion relationship between normalized detection rules, and may measure similarity between the detection rules based on the results of the determination. In this case, a method of determining an inclusion relationship is performed by determining an inclusion relationship between a detection rule obtained after conversion is performed and a detection rule present before conversion is performed. However, the same detection rule ID is excluded.

Therefore, for each item, the detection rule option is compared using the following combination. In FIG. 4, when the ID of a detection rule is 123, inclusion relationships with the remaining IDs, that is, IDs 124, 125, 126, 127, and 128 other than 123, are calculated.

A method of determining an inclusion relationship between character strings of the detection rule options is performed by using the content of the detection rule as a regularly expressed search value to check whether the content of other detections rules has been searched for.

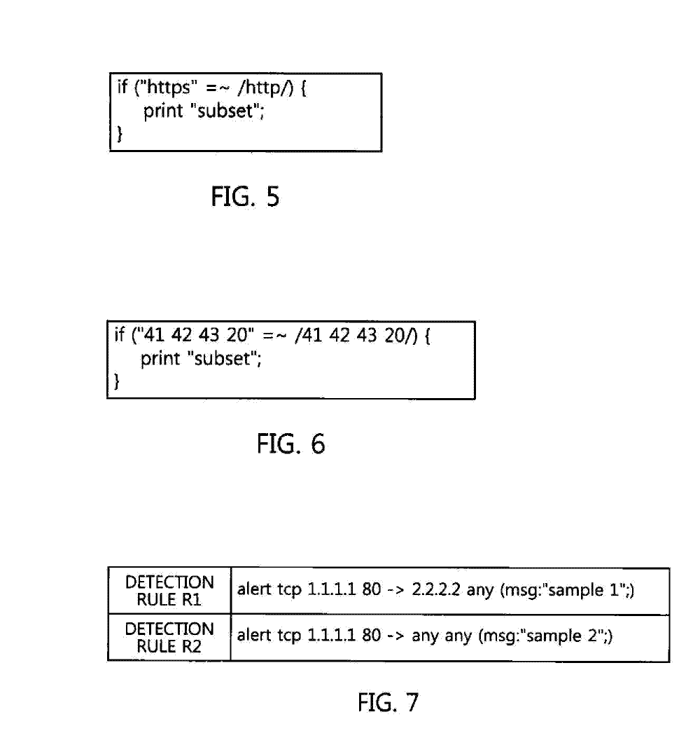

For example, in FIG. 4, code required to determine an inclusion relationship between 123 rule and 126 rule is illustrated in FIG. 5. Here, pert is used as the code. As a result of the determination of the inclusion relationship, the conclusion that the 123 rule includes the 126 rule may be derived. That is, a relationship of 123⊃126 is satisfied.

In the content of the detection rule option, there is a case where a hexadecimal number (Hex value) is included in a character string. In such cases, a comparison between character strings (a content-content comparison) must be performed after all character strings are converted into hexadecimal numbers. Further, a comparison between a character string and a regular expression (a content-pcre comparison) is performed after all hexadecimal numbers included in the character string are converted into a character string (decimal numbers). For example, in order to determine an inclusion relationship between “abc|20|” having a hexadecimal number |20| and “abc” having a blank character, the code such as that shown in FIG. 6 is used.

Referring to FIG. 6, “abc|20|” is converted into |41 42 43 20|, and “abc” is converted into /41 42 43 20/. In this case, blanks between hexadecimal numbers are inessential.

If, in the content of the detection rule option, hexadecimal numbers (Hex values) are included in a character string, and a comparison between the character string and a regular expression is performed, there is a need to convert all hexadecimal numbers of the content into character values, and thereafter calculate an inclusion relationship between the character string and the regular expression.

The relationship operation unit 400 determines inclusion relationships of detection rule headers and the detection rule options divided by the division unit 300.

In detail, the relationship operation unit 400 determines an inclusion relationship between the detection rule headers. In this case, the relationship operation unit 400 calculates the inclusive relationship by comparing the ranges of respective items of the previously divided detection rule header. If necessary, only part of the items is compared.

Referring to FIG. 7, it is determined that detection rule R1 and detection rule R2 have an inclusion relationship of R1⊂R2.

Then, the relationship operation unit 400 determines an inclusive relationship between the detection rule options. In this case, the relationship operation unit 400 determines the inclusion relationship between the content and the pcre included in the detection rule options, and determines the inclusion relationship between detailed option items included in the detection rule options.

A method of determining the inclusion relationship between detailed option items included in the detection rule options is configured to compare the ranges of respective detailed option items divided by the division unit 300 and to determine the inclusion relationship thereof. If necessary, only part of the items may be compared, and weights may be assigned to perform calculation depending on items upon performing the comparison.

A method of determining an inclusion relationship between content and pcre included in the detection rule options is configured to determine the inclusion relationship using partial character strings created by the division unit 300. Here, the determination of the inclusion relationship is performed by using the content value of one detection rule as the value of a regular expression and by checking whether the content value of another detection rule has been searched for.

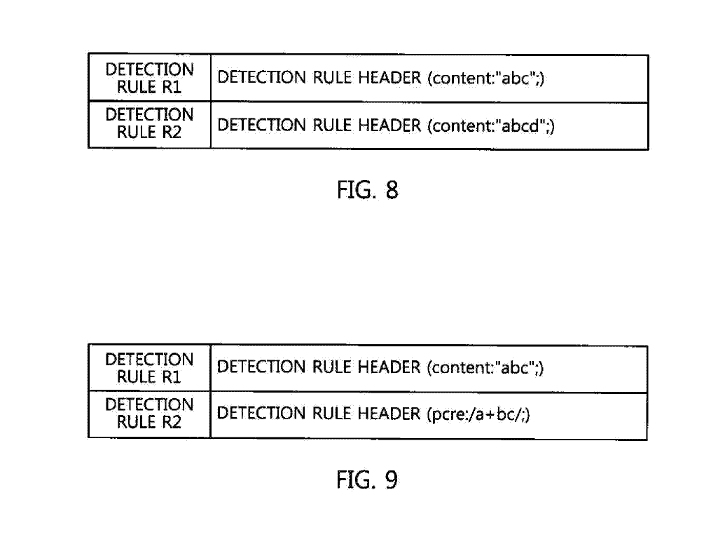

Referring to FIG. 8, it is determined that detection rule R1 and detection rule R2 have an inclusion relationship of R2⊂R1.

Meanwhile, referring to FIG. 9, it is determined that detection rule R1 and detection rule R2 have an inclusion relationship of R1⊂R2.

The similarity measurement unit 500 represents the inclusion relationship between the detection rule headers and the detection rule options by consecutive values, and measures similarity between detection rules based on the consecutive values.

In detail, the similarity measurement unit 500 may represent whether there is the inclusion relationship between the detection rule headers and the detection rule options by non-presence (0) or presence (1) of the inclusion relationship between detection rule R1 and detection rule R2. Further, the degree of similarity between detection rule R1 and detection rule R2 may be represented by the degree of an inclusion relationship corresponding to a real number between 0 and 1.

A method of measuring similarity between detection rules represents similarity by the ratio of matching items to compared items in the method of determining the inclusion relationship between the detection rule headers and the detection rule options performed by the relationship operation unit 400. For example, if all items are compared with each other, and have an inclusion relationship, that is, if all items match each other, the similarity is determined to be ‘1’. In contrast, if part of all items matches each other, similarity may be represented by the ratio of the matching items to all compared items. At this time, weights may be assigned to respective compared items.

The similarity between detection rule headers is obtained by comparing individual values constituting detection rule headers with each other, and is represented by the ratio of the number of matching values to the total number of compared values. For example, if the total number of compared values is N, and the number of matching values as a result of the comparison is M, the similarity between the detection rule headers is represented by the value of M/N.

The similarity between detection rule options is obtained using a method similar to that of measuring the similarity between the detection rule headers. Among the detection rule options, a comparison between contents may be performed to represent similarity by a value between 0 and 1 using an algorithm for measuring a distance between character strings, for example, a Jaro-Winkler algorithm.

If an inclusion relationship is determined by measuring a distance between character strings, the inclusion relationship between two detection rules has a value between 0 and 1, and it may be determined how similar the two detection rules are to each other by using such a value. For example, a value of 0.5 indicates that two detection rules are 50% similar to each other. Similarly, a comparison between content and pcre or a comparison between pcre and pcre may also be performed by measuring a distance between character strings.

The modifier of the remaining detection rule options is configured to lexically compare values and represent similarity by the ratio of the number of matching values to the total number of compared values. If necessary, weights may be assigned to respective modifiers.

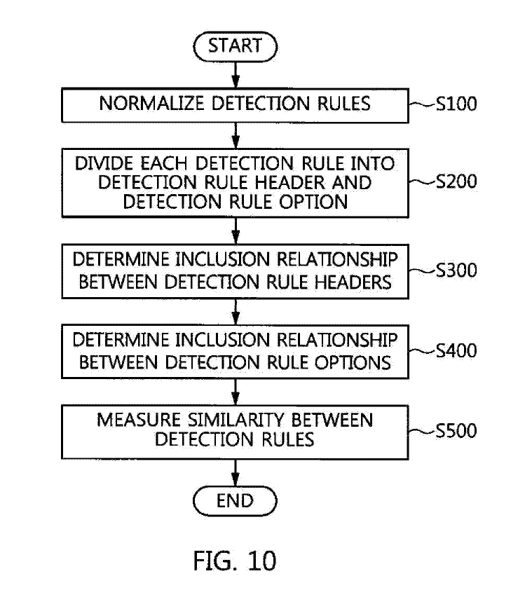

Below, a method of measuring similarity between intrusion detection rules will be described in detail with reference to FIG. 10.

FIG. 10 is a flowchart showing a method of measuring similarity between intrusion detection rules according to an embodiment of the present invention.

First, the apparatus for measuring similarity between intrusion detection rules (hereinafter referred to as “similarity measurement apparatus”) includes different intrusion detection rules (hereinafter referred to as “detection rules”) for respective intrusion detection systems (IDSs).

Referring to FIG. 10, the similarity measurement apparatus performs a normalization procedure for modifying a plurality of detection rules in a predetermined form at step S100. Here, each normalized detection rule is described in the form of a detection rule ID, a delimiter, and a detection character string. Referring to FIG. 3, ‘123’ denotes an ID uniquely identifying each detection rule. c denotes the content of the detection rule option, and is represented by a form put in double quotation marks (“ ”). p denotes pcre of the detection rule option and uses the form described in the detection rule without change.

The similarity measurement apparatus divides each of a plurality of detection rules modified in the predetermined form at step S100, for example, a first detection rule and a second detection rule, into a detection rule header and a detection rule option at step S200. Here, each detection rule may be divided into a detection rule header and a detection rule option, as shown in FIG. 2.

The principal range of the detection rule header is calculated using an action, a protocol, a source IP, a source port, a detection direction, a destination IP, and a destination port.

Further, the principal range of the detection rule option is determined by content and pcre corresponding to a detection target character string. Modifiers such as the offset, distance, depth, and within of the detection rule option may be used to calculate similarity if necessary. Here, the modifiers are used to calculate similarity by lexically comparing the presence or non-presence of the corresponding value, the range of values, etc.

The similarity measurement apparatus determines an inclusion relationship between the detection rule header of the first detection rule and the detection rule header of the second detection rule, divided at step S200, at step S300.

The similarity measurement apparatus determines an inclusion relationship between the detection rule option of the first detection rule and the detection rule option of the second detection rule, divided at step S200, at step S400.

A method of determining an inclusion relationship between the character strings of the detection rule options is configured to use the content of one detection rule as a regularly expressed search value and determine whether content of another detection rule has been searched for.

For example, in FIG. 4, code required to determine an inclusion relationship between 123 rule and 126 rule is illustrated in FIG. 5. Here, perl is used as the code. As a result of the determination of the inclusion relationship, the conclusion that the 123 rule includes the 126 rule may be derived. That is, a relationship of 123⊃126 is satisfied.

In the content of the detection rule option, there is a case where a hexadecimal number (Hex value) is included in a character string. In such cases, a comparison between character strings (a content-content comparison) must be performed after all character strings are converted into hexadecimal numbers. Further, a comparison between a character string and a regular expression (a content-pcre comparison) is performed after all hexadecimal numbers included in the character string are converted into a character string (decimal numbers). For example, in order to determine an inclusion relationship between “abc|20|” having a hexadecimal number |20| and “abc” having a blank character, the code such as that shown in FIG. 6 is used.

Referring to FIG. 6, “abc|20|” is converted into |41 42 43 20|, and “abc” is converted into /41 42 43 20/. In this case, blanks between hexadecimal numbers are inessential.

If, in the content of the detection rule option, hexadecimal numbers (Hex values) are included in a character string, and a comparison between the character string and a regular expression is performed, there is a need to convert all hexadecimal numbers of the content into character values, and thereafter calculate an inclusion relationship between the character string and the regular expression.

The similarity measurement apparatus represents the inclusion relationships between the detection rule headers and the detection rule options determined at step S300 and S400 by consecutive values, and measures similarity between the detection rules based on the consecutive values at step S500.

In detail, the similarity measurement apparatus represents the inclusion relationships of the detection rule headers and the detection rule options by the ratio of matching items to all compared items. For example, if all items are compared with each other, and have an inclusion relationship, that is, if all items match each other, the similarity is determined to be ‘1’. In contrast, if part of all items matches each other, similarity may be represented by the ratio of matching items to all compared items. At this time, weights may be assigned to respective compared items.

The similarity between detection rule headers is obtained by comparing individual values constituting detection rule headers with each other, and is represented by the ratio of the number of matching values to the total number of compared values. For example, if the total number of compared values is N, and the number of matching values as a result of the comparison is M, the similarity between the detection rule headers is represented by the value of MIN.

The similarity between the detection rule options is obtained by comparing the items of the first detection rule with the items of the second detection rule, and is represented by the results of the comparison, that is, the ratio of the number of matching items to the total number of compared target items.

In addition, the results of the comparison between contents of the detection rule options may be represented by a value between 0 and 1 by using an algorithm for measuring the distance between character strings, for example, a Jaro-Winkler algorithm. In this case, in the detection rule options, this algorithm cannot be used in a comparison procedure including pcre.

In this way, the present invention can optimize intrusion detection rules by automatically checking similarity between a large number of intrusion detection rules, and can improve the range of detection by an intrusion detection system using the optimized intrusion detection rules. Further, the present invention automatically checks similarity between intrusion detection rules, thus removing errors that may occur in manual checking, and enabling the present invention to be utilized as a realistic tool for checking detection rules.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

1. A method of measuring similarity between intrusion detection rules, comprising:
modifying a plurality of detection rules stored in a similarity measurement apparatus in a predetermined form;
dividing each of a first detection rule and a second detection rule among a plurality of modified detection rules into a detection rule header and a detection rule option;
determining an inclusion relationship between a detection rule header of the first detection rule and a detection rule header of the second detection rule,
determining an inclusion relationship between a detection rule option of the first detection rule and a detection rule option of the second detection rule; and
measuring similarity between the detection rules based on the inclusion relationship between the detection rule headers and the inclusion relationship between the detection rule options.

2. The method of claim 1, wherein measuring the similarity between the detection rules is configured to compare one or more component values constituting the detection rule header of the first detection rule with one or more component values constituting the detection rule header of the second detection rule, and measure similarity between the detection rules using a ratio of a number of matching component values to a total number of compared component values.

3. The method of claim 1, wherein measuring the similarity between the detection rules is configured to compare one or more component values constituting the detection rule option of the first detection rule with one or more component values constituting the detection rule option of the second detection rule, and measure similarity between the detection rules using a ratio of a number of matching component values to a total number of compared component values.

4. The method of claim 3, wherein each of the options of the first detection rule and the second detection rule comprises content and a modifier.

5. The method of claim 1, wherein a range of each detection rule header is calculated using an action, a protocol, a source Internet Protocol (IP), a source port, a detection direction, a destination IP, and a destination port.

6. The method of claim 1, wherein a range of each detection rule option is determined by content and a regular expression corresponding to a detection target character string.

7. An apparatus for measuring similarity between intrusion detection rules, comprising:
a normalization unit for modifying a plurality of detection rules in a predetermined form;
a division unit for dividing each of a first detection rule and a second detection rule among a plurality of modified detection rules into a detection rule header and a detection rule option;
a relationship operation unit for determining an inclusion relationship between a detection rule header of the first detection rule and a detection rule header of the second detection rule, and determining an inclusion relationship between a detection rule option of the first detection rule and a detection rule option of the second detection rule; and
a similarity measurement unit for measuring similarity between the detection rules based on the inclusion relationship between the detection rule headers and the inclusion relationship between the detection rule options.

8. The apparatus of claim 7, wherein the similarity measurement unit is configured to compare one or more component values constituting the detection rule header of the first detection rule with one or more component values constituting the detection rule header of the second detection rule, and measure similarity between the detection rules using a ratio of a number of matching component values to a total number of compared component values

9. The apparatus of claim 7, wherein the similarity measurement unit is configured to compare one or more component values constituting the detection rule option of the first detection rule with one or more component values constituting the detection rule option of the second detection rule, and measure similarity between the detection rules using a ratio of a number of matching component values to a total number of compared component values.

10. The apparatus of claim 9, wherein each of the options of the first detection rule and the second detection rule comprises content and a modifier.

11. The apparatus of claim 7, wherein a range of each detection rule header is calculated using an action, a protocol, a source Internet Protocol (IP), a source port, a detection direction, a destination IP, and a destination port.

12. The apparatus of claim 7, wherein a range of each detection rule option is determined by content and a regular expression corresponding to a detection target character string.

13. The apparatus of claim 7, wherein the similarity measurement unit lexically compares values of a modifier, among component values of the detection rule options, and represents similarity by a ratio of a number of matching values to a total number of compared values.

14. The apparatus of claim 13, wherein the similarity measurement unit is capable of setting weights to the modifier values.
